(19) United States
(12) Patent Application Publication
(10) Pub. No.: US 2005/0268553 A1
(43) Pub. Date: Dec. 8, 2005

(54) Hybrid water gas shift system

(76) Inventors: Ke Liu, East Longmeadow, MA (US); John G. Buglass, Glastonbury, CT (US); John L. Preston JR., Hebron, CT (US); Tianli Zhu, South Windsor, CT (US); Ronald Jan Schoonebeek, Castricum (NL)

Correspondence Address: Stephen A. Schneeberger, 49 Arlington Road, West Hartford, CT, 06107, US

(21) Appl. No.: 10/861,648

(22) Filed: Jun. 4, 2004

(51) Int. Cl. B01J 7/00

(52) U.S. Cl. 48/61

(57) ABSTRACT

A fuel processing system (FPS) (120, 220, 320) provides a hydrogen-rich reformate having a reduced level of CO (34, 234, 62), as for use in a fuel cell power plant (120). The FPS includes, in combination, a reformer (30, 230) for converting hydrocarbon feedstock (22) to reformate and a multistage hybrid WGS reactor (150, 250, 350) for converting CO with H₂O in the reformate to H₂ and CO₂ to reduce the CO in the reformate. The multistage hybrid WGS reactor (150, 250, 350) has one stage (154, 254, 352) of active noble metal catalyst (174, 274, 374), typically platinum and/or rhenium, and an other stage (152, 252, 354) of Cu-based WGS catalyst (172, 272, 372), e.g. Cu/ZnO, whereby the collective volume of the one and the other stages is relatively small, being less than about ½ that of prior WGS reactors. The Cu-based WGS catalyst may be modified to reduce self-heat. Protection from sulfur in the reformate is also provided. The multistage hybrid WGS reactor (150, 250, 350) may further include an O₂ guard.

### TECHNICAL FIELD

This invention relates generally to the processing of feedstocks to produce hydrogen, and more particularly to the water gas shift reactor(s) and processes employed to provide a low-CO, hydrogen-rich fuel stream from various hydrocarbon feedstocks (including alcohols).

### BACKGROUND ART

It is well known to process hydrocarbon feedstocks, to derive hydrogen-rich streams for various uses, including as a fuel in fuel cell power plants, as partly refined feedstock in the manufacture of ammonia, as a feedstock to the hydrogen-treating unit in a refinery to produce clean fuels, etc. The term “hydrocarbons”, as used herein, should be viewed as including not only the heavier C—H-only hydrocarbons, but also the alcohols and other oxygen-containing hydrocarbons as well as various biomass extracts, at least to the extent they contain the presence of objectionable levels of sulfur. It is also well known to use the water gas shift reaction in fuel processing systems that provide hydrogen-rich streams, and that the catalysts used in the water gas shift reactions are important not only for their role in promoting the reactions, but also for their cost and weight/volume impact on the system, as well as their susceptibility to adverse effects from sulfur. To better understand both the problems and the solutions provided by the invention, they will be discussed in the context of a fuel processing system used in conjunction with a fuel cell power plant. However it should be understood that both the problems and solutions extend to a broader range of applications than just fuel cell power plants.

Fuel cell power plants that utilize a fuel cell stack, as for instance of PEM fuel cells, for producing electricity from a hydrocarbon fuel source are well known. The raw hydrocarbon fuel may be natural gas, gasoline, diesel fuel, naphtha, fuel oil, methanol, ethanol, or the like. In order for the hydrocarbon fuel to be useful in the fuel cell stack's operation, it must first be converted to a hydrogen-rich process or fuel stream through use of a fuel processing system. Such hydrocarbon fuels are typically passed through a reformer to create a process fuel (reformate) having an increased hydrogen content. The reformate exiting from a reformer has about 10% to 20% carbon monoxide (CO) and is introduced into the water-gas-shift (WGS) reactor to further convert CO and H₂O to H₂ and CO₂. The resultant reformate contains primarily water, hydrogen, carbon dioxide, and carbon monoxide.

Cathode and anode electrodes, which form part of the fuel cell stack, can be “poisoned” by a high level of carbon monoxide. Thus, it is necessary to reduce the level of CO in the reformate, prior to flowing the reformate to the fuel cell stack, by passing the reformate through a water gas shift reactor (or WGS reaction section) having one or more WGS stages, and possibly additional reactors, such as one or two selective oxidizers, prior to flowing the process fuel to the fuel cell stack. The shift reactor also increases the yield of hydrogen in the reformate stream. Depending on the catalyst used in the WGS reactor(s), the physical volume/weight/size of the WGS reactor may be significant. Catalyst cost also varies significantly, depending upon the catalyst selected, the quantity required, and any preconditioning required. These factors will be discussed in greater detail hereinafter.

The raw hydrocarbon fuel source typically also contains sulfur or sulfur compounds, and the presence of sulfur results in a poisoning effect to varying degrees on all of the fuel processing catalysts, as well as in the fuel cell anode and cathode catalysts. To mitigate this problem, the hydrocarbon fuel source is typically passed through a desulfurizer, either prior to or following the reforming process, to remove in a known manner, as by converting sulfur from the gaseous form to a solid, substantial quantities of sulfur prior to the fuel entering the sulfur-sensitive components of the fuel processing system and fuel cell. Examples of such desulfurizers and descriptions of the associated process may be found in U.S. Pat. Nos. 5,769,909 and 6,159,256. Additionally, a U.S. Pat. No. 6,299,994 discloses the use of desulfurizers and other components of various fuel processing systems with the goal of providing a “pure” hydrogen stream for the fuel cell.

In a typical example, natural gas feedstock may have a sulfur content of ˜6 ppm-wt. Though substantial sulfur is removed by the desulfurizer from the hydrocarbon fuel stream being processed, nevertheless sulfur levels of 25 ppb-500 ppb-wt. fuel or greater, typically remain. Such diminished levels of sulfur in the fuel may be tolerated by the catalysts in the reformer and especially in the catalytic partial oxidizer, in part due to higher operating temperatures. The reforming process dilutes the fuel stream such that the resulting reformate may typically have sulfur levels in the range of 5 ppb-1000 ppb wt in the reformate. While the catalysts used in the prior art in the remaining elements of the fuel processing system and the fuel cell itself may have tolerated such sulfur levels in the reformate, the present more active, noble metal catalysts tend to result in increased sensitivity to sulfur, even at the reduced sulfur levels in the reformate.

Referring to FIG. 1, there is depicted, in simplified functional schematic diagram form, the fuel cell stack assembly (CSA) 16 and a conventional fuel processing system (FPS) 20 of a fuel cell power plant 10 in accordance with the Prior Art as described above. Briefly, hydrocarbon fuel feedstock, typically containing sulfur, represented by supply line 22, is delivered by a pump (liquid feed) or blower (gas feed) 24 to a desulfurizer 26 at the input, or upstream end, of FPS 20. The sulfur may be present in the form of hydrogen sulfide (H₂S), as well as mercaptans, sulfur oxides, etc. Following high-level desulfurization, the hydrocarbon fuel feedstock is admitted to a reformer 30 where, in the presence of steam, and possibly air, supplied on line 32, it is reformed in a well known manner to provide a hydrogen-rich reformate on line 34. The reformer 30 may be of a variety of types, including a catalytic steam reformer (CSR), an autothermal reformer (ATR), a catalytic partial oxidizer (CPO), or the like, with the ATR and CPO typically requiring the supplemental air for the reaction. The reformate, in addition to containing H₂ and CO, also contains any residual low level sulfur (H₂S) not removed by the desulfurizer 26. That sulfur may be present at the level of about 5 ppb-1000 ppb-wt. reformate, or greater. The result is substantially the same if the high-level desulfurization occurs immediately after the reformer 30 rather than before. Depending upon the type of reformer/reformation process used, the reformate may also include components of air, such as nitrogen and a small amount of unconverted oxygen during start-up or shutdown of the reformer.

The reformate on line 34 is typically supplied directly to a water gas shift reaction section, or reactor, 50 that typically contains a first stage (typically high temperature) shift reactor 52 connected by line 53 to a second stage (typically low temperature) shift reactor 54. Optionally, in accordance with a recent development, the reformate may be first flowed through a “guard bed” 70 containing a guard material 72, and thence via line 134 to the WGS reaction section 50. The guard material 72 may be ZnO, CuO, Cu/ZnO, Ce oxides, metal-doped Ce oxides typically of Ce/Zr or Ce/Pr, Mn oxide, Mg oxide, Mo oxide, Zr oxide, and Co oxide, either alone or in combination with a CeO₂-based support, and serves to adsorb or remove sulfur and form stable sulfides, from levels of H₂S (5-1000 ppb) in the process fuel stream.

The shift reaction section 50 serves in a known manner to react CO with H₂O in the reformate to become CO₂ and to increase the yield of H₂. In the main, the prior art shift reactors 52 and 54 have employed catalysts such as Cu/ZnO (for LTS) and Fe/Cr oxide (for HTS). The presence of the non-noble-metal catalysts, such as Fe/Cr oxide in the high temperature shift reactor 52 and Cu/ZnO in the low temperature shift reactor 54, has provided sufficient additional sulfur sorbing action with respect to the residual low level sulfur to further decrease the sulfur levels such that they would not poison the more-sulfur-sensitive catalysts downstream thereof. Following passage through the shift reaction section 50, the hydrogen-rich reformate may then pass through a selective oxidizer (SOX) 60 connected through line 56 from low temperature shift reactor 54, and thence to the anode 18 of CSA 16 connected through line 62 from the selective oxidizer 60. Partially-spent hydrogen is discharged from anode 18 via discharge line 19, and may be recycled and/or may be combusted to provide a source of heat.

Heretofore, the water gas shift catalysts of the shift converter portion of the fuel processing system have conventionally been Cu/ZnO at the LTS reactor and/or Fe/Cr oxide at the HTS reactor, and have incidentally served to adsorb the residual sulfur sufficiently to prevent poisoning of the system there and downstream thereof. This is due partly to the fact that they are used in relatively large quantities due to their limited catalytic activity. While these catalysts are of moderate relative cost, the volume required was relatively large and thus contrary to a desire to minimize weight and volume, particularly in mobile applications. For example, as a point of reference, the volume of the catalyst bed in the WGS 150 of FIG. 1 is about 9 cubic feet to obtain a level of CO less than 1.5% in one exemplary fuel cell system of 150-200 Kw size. Recently, however, there has been a change in the type of shift catalyst used in the shift conversion process, from Cu/ZnO and/or Fe/Cr oxide to relatively much more active catalysts, such as noble metal-based catalysts and some active base metal catalysts. Though typically more expensive, these more-active catalysts offer advantages in the shift conversion reaction process and elsewhere in the system, principally by requiring smaller quantities than heretofore and thus permitting smaller weights and/or volumes. Moreover, catalysts such as Cu/ZnO have a well-known problem of pyrophoricity, owing to their exothermicity when exposed to air, and thus require special procedures for handling and shipping, since they should not be exposed to air. For brevity, this property/problem will be referred to herein as “self-heat” or “self-heating”. This is particularly so at the conventional concentrations of about 30% Cu or greater in the catalyst. On the other hand, the noble metal-based catalysts may be more susceptibile to sulfur poisoning, particularly in the absence of the sorbing action of the Cu/ZnO. This is so, even at the low levels of sulfur in the range of 5 ppb-1000 ppb-wt. reformate, and may be particularly a problem during warm-up or turn-down, when the sulfur levels go higher.

Accordingly, there is a need to use a catalyst arrangement in the water gas shift reaction section of a fuel processing system that reduces the size of the WGS reaction section, yet which also optimizes the economics of the system and/or guards those catalyst(s) against sulfur in the fuel/reformate.

There is further need to provide such catalyst arrangement in a WGS reaction section following differing types of reformers

There is a still further need to provide an effective and relatively compact arrangement for removing, or reducing, low, objectionable levels of sulfur from a hydrocarbon process stream, as for a fuel cell in a fuel cell power plant.

### DISCLOSURE OF INVENTION

An improved fuel processing system (FPS) for providing a hydrogen-rich reformate stream is structured and operative to reduce the size of at least its water gas shift reaction section. Moreover, the water gas shift reaction section is constituted in a manner that additionally protects the active noble metal catalysts in that and following sections from the poisoning effects of even low levels of sulfur (S) in the reformate stream. The improved FPS is suited for use in a variety of applications using a hydrogen-rich reformate and typically seeking a degree of hydrogen clean-up, as for example in a fuel cell stack assembly (CSA) of a fuel cell power plant, in industrial processes utilizing hydrogen, and/or a variety of other like applications.

A fuel processing system is provided for receiving and converting a hydrocarbon feedstock fuel to a hydrogen-rich reformate stream, and includes a reformer for reforming the hydrocarbon feedstock fuel to a hydrogen-rich reformate having a first level of carbon monoxide (CO) and a multistage hybrid water gas shift (WGS) reactor for converting CO with H₂O in the reformate to H₂ and CO₂. The multistage hybrid WGS reactor comprises one stage of active noble metal catalyst and an other stage of a Cu-based catalyst, whereby the collective volume of the one and the other of the WGS stages is relatively smaller than for the prior art. The Cu-based catalyst may preferably be in the form of Cu/ZnO and the active noble metal catalyst may preferably be platinum (Pt) and/or rhenium (Re), though other oxides and noble metals may also be used. It is further preferred that the Cu/ZnO catalyst be lightly loaded on a support, preferably a relatively large surface area and high thermal conductivity support, to minimize self heating that may otherwise occur.

The foregoing hybrid arrangement provides the dual advantages of reduced size/volume of the WGS section of the FPS and a concomitant protection or “guarding” against sulfur poisoning without the requirement of a separate guard bed.

In a representative application, such as a fuel cell power plant, gross high level sulfur removal, to levels in the range of 100 ppb-50,000 ppb-wt. fuel, or greater is performed by a desulfurizer located upstream of a reformer. After gross sulfur removal, reformate from the reformer may have sulfur levels further diluted to levels in the range of 5 ppb-1,000 ppb-wt reformate, and is supplied to a hybrid water gas shift reaction section of the invention for the conversion of CO and H₂O to CO₂ and H₂ and further, for protection against residual levels of sulfur in the reformate. Typically, the WGS reaction section comprises a 1^{st} stage shift reactor and a 2nd stage shift reactor, with one of the stages employing a relatively active noble metal catalyst, and the other stage employing a base metal WGS catalyst, such as Cu/ZnO catalyst with a low level of Cu wash-coated onto a high-surface-area and highly thermally-conductive support. Cumulatively, the two stages of the WGS reaction section are of relatively small volume/size, typically being less than about ½ to ⅕ the size required for the WGS reaction section 50 of the FIG. 1 embodiment conventional in the prior art.

In a preferred embodiment, there is provided a hybrid water gas shift reactor in which the 1^{st} stage water gas shift reactor includes a base-metal WGS catalyst, such as Cu/ZnO or the like, and the 2^{nd} stage shift reactor includes an active noble metal catalyst, such as Pt or the like. Typically, the rate expression of the Cu/ZnO WGS catalyst is close to first order in partial pressure of CO, which makes the reaction order suited for first stage shift when the CO concentrations are high. Conversely, the Cu/ZnO WGS catalyst will have a relatively slow reaction rate at low temperature shift conditions not only because the temperatures are low, but also because the CO concentration is low. By contrast, the active noble metal catalyst rate expression tends toward zeroth-order in CO partial pressure, which allows the active noble metal catalyst to exhibit high activity even at low CO concentrations. The Cu/ZnO of the 1^{st} stage WGS reactor serves as both a water gas shift catalyst and a sulfur adsorber, but, importantly, at a Cu loading that is sufficiently low that it avoids or minimizes shipping and handling requirements due to self-heating. In a conventional CuZnO catalyst, typical Cu loadings are about 33% Cu. However, the invention provides a Cu/ZnO catalyst in which the Cu is sufficiently lightly loaded on a support, as by coating, that the catalyst will not exceed a 60° C. maximum delta T temperature rise during shipping as a result of any self heating. This light Cu loading, as a total of the combined Cu/ZnO catalyst and its support, may preferably be about 2.0%. Accordingly, the combined attributes of the low loading of Cu for its WGS and sulfur trapping capabilities without threat of excessive self-heating, together with the high activity and relatively compact volume of the noble metal catalyst, result in a 2-stage WGS reactor of reduced size that nevertheless retains the WGS and sulfur trapping capabilities of prior relatively larger systems.

While the hybrid WGS reaction section of the preceding embodiment is particularly suited for use with a reformer of the CSR type, one or more other embodiments are better suited for use in FPS's in which the reformer is of the CPO type having relatively higher temperatures and potential oxygen leakage during start-up, shutdown, and/or transient operations. Specifically, in one embodiment, a supplemental catalyst guard bed of noble metal catalyst, e.g., platinum, may be part of the WGS section and precede the 1^{st} stage WGS reactor containing the Cu/ZnO, and serves as an oxygen guard for converting excess oxygen passed through the CPO reformer. The 2^{nd} stage WGS reactor continues to have a noble metal catalyst, such that the WGS section includes a Cu/ZnO catalyst preceded and followed by a noble metal catalyst. Heat exchangers (Hex) may precede and/or follow one or more of the catalyst beds recited above. To the extent oxygen leakage might also be a problem with a CSR type reformer, a similar configuration may be used but is generally not required.

In another, less-preferred embodiment in which the hybrid WGS reactor follows a CPO-type of reformer, the catalyst of the 1^{st} stage WGS reactor is active noble metal such as Pt and the catalyst of the 2^{nd} stage WGS reactor is the Cu/ZnO. A heat exchanger (Hex) may be located between the 1^{st} and the 2^{nd} stages of the WGS reactor for cooling the reformate issuing at about 300°-450° C. from the 1^{st} stage WGS reactor to about 175°-225° C. This configuration is less than optimum because the Cu does not convert CO as efficiently at low concentrations and because the Pt of the 1^{st} stage WGS reactor may suffer from exposure to sulfur, though it may contribute to guarding against excess oxygen.

The foregoing features and advantages of the present invention will become more apparent in light of the following detailed description of exemplary embodiments thereof as illustrated in the accompanying drawings.

### BRIEF DESCRIPTION OF DRAWINGS

FIG. 1 is a simplified functional schematic diagram of a conventional fuel processing system, illustrated in the context of a fuel cell power plant having a fuel cell stack assembly and a fuel processing system in accordance with the prior art;

FIG. 2 is simplified functional schematic diagram of a fuel cell power plant and fuel processing system similar to FIG. 1, but showing a fuel processing system having a hybrid shift reactor in accordance with one embodiment of the invention;

FIG. 3 is a simplified fragmentary view of a fuel processing system similar to but using a different reformer than that of FIG. 2, and illustrating a hybrid shift reactor in accordance with another embodiment of the invention; and

FIG. 4 is a simplified fragmentary view of a fuel processing system similar to that of FIG. 3, illustrating a hybrid shift reactor in accordance with yet another embodiment of the invention.

### BEST MODE FOR CARRYING OUT THE INVENTION

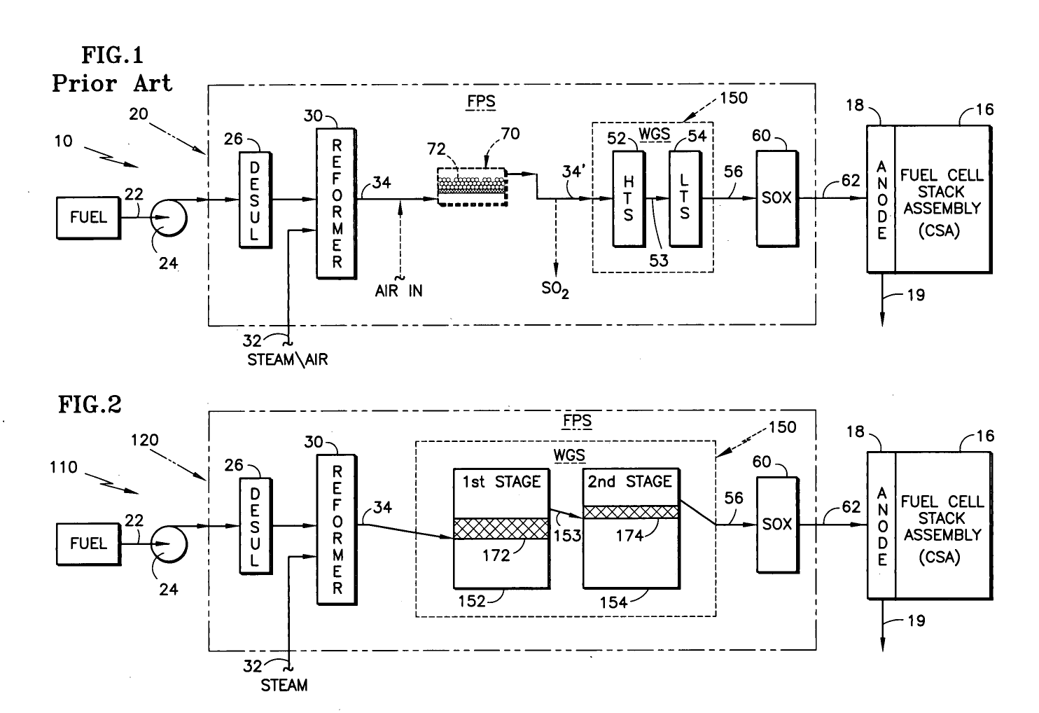

Referring to FIG. 2, there is illustrated a fuel cell power plant 110 similar to that depicted in FIG. 1 with respect to the prior art, but differing principally in that it includes a fuel processing system (FPS) 120 with a hybrid water gas shift (WGS) reaction section, or simply “WGS reactor”, in accordance with a principal embodiment of the invention. The elements of FIG. 2 that are essentially the same as their counterparts in FIG. 1 are given the same reference numeral as in FIG. 1, whereas those elements that are functionally similar but include some change in accordance with the invention, are similarly numbered but with a “1” prefix. Added elements are given new numbers. The CSA 16 is typically of the proton exchange membrane (PEM) type, operating at temperatures less than 100° C. It will be understood that the power plant 110 includes various elements and sub-systems that are well understood and a part of the normal functioning of the system, but which are not described herein because they are not essential to an understanding of the invention and its benefit to the system. Moreover, it will be understood that although the several embodiments of the invention described herein are in the context of use in a fuel cell power plant, the invention has use and applicability in a variety of applications which use a hydrogen-rich reformate and desire a degree of hydrogen clean-up.

As noted previously, a sulfur-containing hydrocarbon fuel feedstock, represented by supply line 22, is delivered by a pump or blower 24 to a desulfurizer 26 at the input, or upstream end, of FPS 120. The hydrocarbon feedstock 22 may typically be natural gas, gasoline, propane, diesel, naphtha, fuel oil, methanol, ethanol, or the like, and is likely to contain various forms of sulfur at levels sufficient to pose a poisoning potential for the various noble metal catalysts in the system. The hydrocarbon fuel feedstock is delivered to the FPS 120, and specifically a desulfurizer 26, by means of a pump, blower, or the like. The desulfurizer 26 is generally capable of reducing sulfur levels in the hydrocarbon feedstock 22 to levels of about 25 ppb-500 ppb-wt fuel, following which the feedstock is supplied to a reformer 30, for conversion or reformation at high temperature, e.g., 600-800° C., through the addition of steam (and possibly air) 32, to form a hydrogen-rich reformate that also includes significant CO. In the FIG. 2 embodiment, the reformer 30 is assumed to be of the CSR type and the reformate typically includes a relatively low level of O₂. That reformate is provided on output line 34 from the reformer 30, and continues to contain residual sulfur at or below the levels provided by the desulfurizer 26, typically diluted by the reforming process, such that sulfur levels of 5 ppb-100 ppb-wt reformate remain. It should be understood that the relative locations of the desulfurizer 26 and the reformer 30 may be reversed, with a similar result occurring, because of the reformer's higher operating temperature-tolerance of sulfur, particularly if it is a CPO or ATR, and/or if possibly lower levels of sulfur are present in the hydrocarbon fuel feedstock.

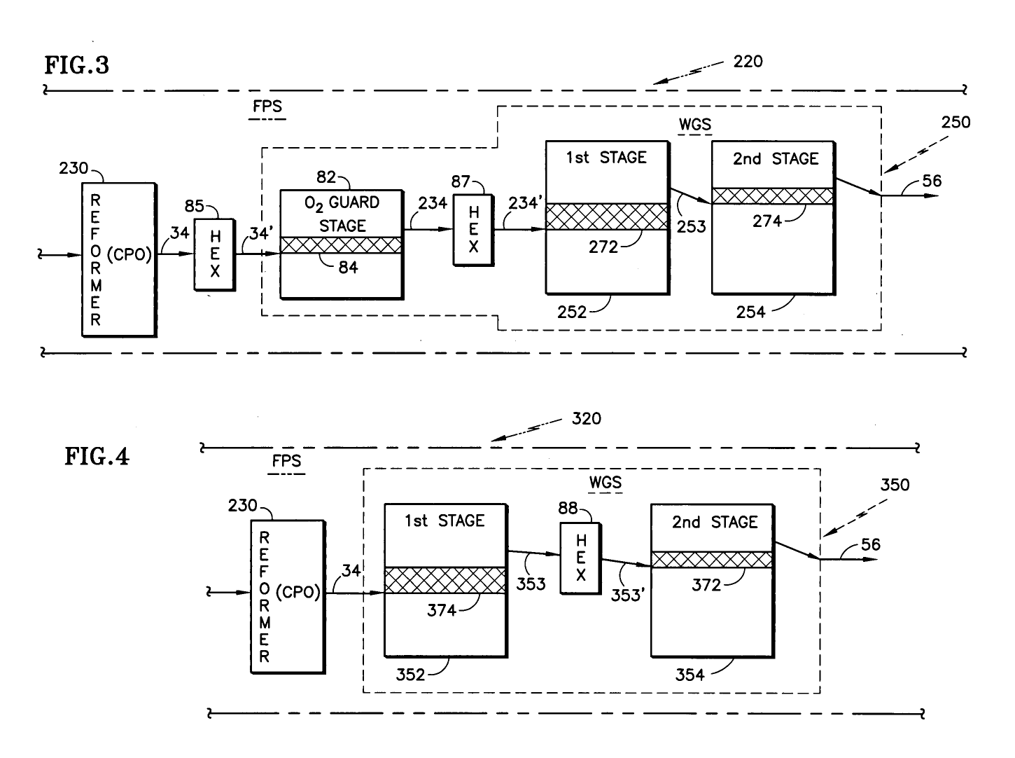

To reduce the level of CO in the reformate 34, the reformate undergoes a shift reaction in the hybrid water gas shift (WGS) section 150 of the invention to shift CO and H₂O to CO₂ and H₂, and further, to “trap” excess sulfur. Indeed, emphasis is on the water gas shift reaction function provided by the arrangement of the hybrid WGS reactor 150 and associated catalysts, and the sulfur trapping capability is a beneficial adjunct. Rather than refer to the various stages of the hybrid WGS section 150 by relative temperatures, i.e., high and low, they will be referred to by flow sequence, i.e., 1^{st} stage and 2^{nd} stage, with a slight modification of this convention occurring in the description and depiction of the FIG. 3 embodiment, as will be evident. The flow sequence is a constant, whereas the relative operating temperatures of the two or more stages may vary in sequence.

The reformate on line 34 is supplied to and flowed through the 1^{st} stage water gas shift reactor 152 for the combined functions of a limited shifting of CO to CO₂, enrichment of the H₂ stream, and for sulfur removal. The catalyst media or bed 172 in the 1^{st} stage WGS reactor 152 utilizes a Cu-based catalyst, such as Cu/Zn oxide (Cu/ZnO) catalyst, in a low-loading concentration to serve as a WGS catalyst and to trap sulfur, without possessing a self heating problem that would restrict or prevent its handling and shipping. Moreover, the use of Cu/Zn oxide affords a monetary cost economy with a limited penalty because of size.

In accordance with an important aspect, the catalyst of media or bed 172 is formed by coating, as by wash coating, a low Cu load of Cu/ZnO WGS catalyst onto a high surface area metal catalyst support. The metal of the support has better thermal conductivity than the more conventional ceramic support, and may be a monolith of stainless steel foils or FeCralloy materials, formed as a lightweight mesh, a foraminous honeycomb or wafer, or the like, to have very large surface areas of up to 1000 cells per square inch (155 cells/cm²). The metal support provides good thermal conductivity and can readily cope with short-term temperature excursions up to 1300° C., withstands prolonged strain, and gives good cold start performance. Of course, the catalyst may alternatively be coated on metallic pellets, though perhaps at some penalty to surface area per unit volume. The Cu is preferably present in the form of Cu/ZnO, though other Cu/oxides may also suffice, such as Cu/CeO. Importantly, the loading of the Cu on the metal support is kept significantly lower than conventional, which might normally be 33% or greater and present possible self-heating problems. However, the invention provides a Cu/ZnO catalyst in which the Cu is sufficiently lightly loaded on a support, as by coating, that the catalyst will not exceed a 60° C. maximum delta T temperature rise during shipping as a result of any self heating. This light Cu loading, as a total of the combined Cu/ZnO catalyst and its support, may preferably be about 2.0%. Such dispersion of the Cu catalyst over a large surface area having good thermal conductivity assures both good catalytic activity from even the relatively reduced amount of Cu while also reducing the self-heating problem as a result of the lower loading. Correspondingly, such loading of Cu on the metal support results in a catalyst media, or catalyst bed, 172, that serves the dual function of facilitating the water gas shift reaction for converting CO and H₂O to CO and H₂ as well as reducing sulfur levels to those indicated with respect to the FIG. 1 embodiment without requiring the sulfur guard 70 thereof.

The effluent from the first stage WGS reactor 152 is supplied via line 153 to the 2^{nd} stage WGS reactor 154 that contains an active noble metal shift catalyst, represented by catalyst bed 174, for shifting CO and H₂O to CO₂ and H₂. The active noble metal shift catalyst 174 of the 2^{nd} stage WGS reactor 154 may be selected from the group comprising platinum, rhenium, ruthenium, palladium, rhodium, gold and, possibly, osmium and/or silver, alone or in combination, with platinum and platinum-rhenium being particularly preferred because of a desirable level of activity per volume. The noble metal shift catalysts may be advantageously supported by, or on, a metal oxide promoted support, in which the metal oxide may be an oxide of cerium (ceria), zirconium (zirconia), titanium (titania), yttrium (yttria), vanadium (vanadia), lanthanum (lanthania), and neodymium (neodymia), with ceria and/or zirconia being generally preferred, with or without doping with a third metal such as lanthanum, hafnium, titanium, and/or tungsten, and a combination of the two being particularly preferred. Additional disclosure regarding these noble metals and metal oxide promoted supports may be found in U.S. Pat. No. 6,455,152 to R. G. Silver and published U.S. patent application Ser. No. 10/402,808 of T. H. Vanderspurt having Publication Number US-2003-0235526-A1.

This use of a very active noble metal shift catalyst enables the associated catalyst bed 174 to be relatively compact in size and volume. Accordingly, the combined attributes of the low loading of Cu oxide for its WGS and sulfur trapping capabilities without threat of excessive self-heating, together with the high activity and relatively compact volume of the noble metal catalyst, result in a hybrid WGS reactor 150 of reduced size that nevertheless retains the WGS and sulfur trapping capabilities of prior, relatively larger systems. By way of comparative example, whereas the WGS reactor 50 of the FIG. 1 system may require a volume of about 9 cubic feet to obtain a level of CO less than 1.5%, that same result may be obtained in the FIG. 2 system with a hybrid WGS reactor 150 having a cumulative volume of typically less than about 2.5-4.5 cubic feet, or a reduction in the range of about 2:1-3.5:1 or better, with the Cu/ZnO catalyst 172 and reactor stage typically requiring several times the volume of the Pt catalyst 174 and reactor stage. Moreover, this result may be obtained together with concomitant protection from sulfur in the reformate without reliance on a separate sulfur guard bed independent of the WGS section.

In the FIG. 2 embodiment, the reformer 30 is assumed to be of the catalytic steam reformer (CSR) type, and the reformate on line 34, which may be at about 650° C. when leaving the reformer 30, is introduced to the 1^{st} stage WGS reactor 152 at a temperature in the range of 160-250° C., typically about 190° C. following a cooling down by a heat exchanger (not shown) in line 34. The reaction in the reactor 152 is exothermic and the exiting effluent is supplied via line 153 to the 2^{nd} stage WGS reactor 154 at a temperature in the range of 200-350° C., typically about 250° C. The reaction in the reactor 154 liberates some additional heat, and the effluent exiting that reactor via line 56 may be at a temperature in the range of about 250-400° C., preferably less than 300° C. Thus it will be seen that this configuration reverses the sequence of “high” and “low” temperature reactors relative to the FIG. 1 embodiment.

In the event the reformer is of the autothermal reformer (ATR) or the catalytic partial oxidizer (CPO) type in which air is used in the reaction, such as the reformers 230 in the FIGS. 3 and 4 embodiments, the resulting reformate may include nitrogen and unconverted oxygen, especially during start-up, shutdown, and/or transient operations, that are not otherwise present in the reformate from a CSR reformer. Moreover, the percentage of hydrogen in the reformate may be significantly less, and there may be significant quantities of nitrogen and unreacted oxygen. While the nitrogen does not present any particular problem, it is preferable that the oxygen be removed or otherwise converted. If the level of that O₂ is relatively low, the WGS section 150 of the FIG. 2 embodiment may be able to handle the oxygen without additional equipment. However, if the level of the O₂ is excessive, it may be necessary and desirable to eliminate that O₂ by oxidizing H₂ and some CO. This is facilitated by the presence of a noble metal catalyst, such as platinum, and may be accomplished by including an additional stage of platinum catalyst following the reformer 230 and preceding the 1^{st} stage WGS reactor 252 of the hybrid WGS reactor 250 of FIG. 3, or by reconfiguring the sequence of reactor stages as depicted in the hybrid WGS reactor 350 of FIG. 4.

Reference is made first to the embodiment of FIG. 3, which is abbreviated from FIGS. 1 and 2. Although it similarly concerns a water gas shift reactor/sulfur guarding arrangement for a fuel processing system as might be used in a fuel cell power plant or the like, for the sake of brevity and simplicity FIG. 3 illustrates only that portion, or fragment, of the overall system in which the variants of the particular embodiment occur. The elements of FIG. 3 that are essentially the same as their counterparts in FIG. 2 are given the same reference numeral as in FIG. 2, whereas those elements that are functionally similar but include some change in accordance with this embodiment of the invention, are similarly numbered but with a “2” prefix. Elements not depicted in FIG. 2 are given new numbers.

In FIG. 3, an O₂ guard bed 82 containing a bed 84 of noble metal catalyst, such as Pt or the like, is located between the CPO reformer 230 and the 1^{st} stage WGS reactor 252 of the hybrid WGS reactor 250. While the O₂ guard bed 82 might be depicted separately from the hybrid WGS reactor 250, it is more appropriate to illustrate and describe it as part of the WGS reactor 250 because it does perform a water gas shift reaction as well as providing the O₂ guard function. Except for the inclusion of the O₂ guard bed 82 and some associated heat exchangers (Hex), the hybrid WGS reactor 250 is structured and constituted similarly to the reactor 150 of FIG. 2, with a first stage WGS reactor 252 having a Cu/ZnO catalyst bed 272 followed by a second stage WGS reactor 254 having a Pt catalyst bed 274. The O₂ guard bed may be small, similar to or even less than the volume of the other noble metal catalyst bed 274 in the 2^{nd} stage WGS reactor 254, such that the cumulative volume of the O₂ guard bed 82, the first stage WGS reactor 252, and the second stage WGS reactor 254 is only a little greater than for the FIG. 2 embodiment, e.g., 3 cu ft.

Reformate containing excess O₂ from reformer 230 is supplied, via line 34, a temperature-reducing Hex 85, and line 34′, to the O₂ guard bed 82 at a temperature greater than 200° C., where some of the excess O₂ is eliminated by oxidizing some H₂ and CO. Moreover, because a water gas shift reaction occurs, some CO is converted to CO₂. Because of the high operating temperature, the Pt catalyst bed 84 of the O₂ guard bed receives protection against degradation or poisoning by sulfur in the reformate, at least with respect to the combustion of the excess O₂. However, the sulfur may adversely affect, or limit, the WGS reaction at that O₂ guard bed 82. The reformate exits the O₂ guard bed 82 via line 234 and is supplied, via temperature-reducing Hex 87 and line 234′, to the first stage 252 of the hybrid WGS reactor 250 for further CO conversion by the WGS reaction, as well as protection against excess sulfur. The remainder of the WGS reaction occurs as described with respect to the operation of hybrid reactor 150 of FIG. 2.

A further embodiment, of a modified hybrid WGS reactor, is depicted in FIG. 4, illustrating a reversal in the sequence, relative to the FIG. 2 embodiment, of the noble metal and the Cu/ZnO beds relative to the flow of reformate thereover. Specifically, reformate from CPO reformer 230 is supplied, via line 34, to the first stage 352 of a modified hybrid WGS reactor 350. However, the catalyst bed 374 in that first stage is of a noble metal, such as Pt or Pt—Re, and thus the change in the reference numeral convention. The relatively higher exhaust temperature of the CPO reformer 230 (about 800° C.) vis a vis that of CSR reformer 30 (about 650° C.) requires increased cooling via a Hex (not shown) to attain a reformate temperature of about 350° C. Controlling the inlet temperature of reformate to the catalyst bed 374 to be about 350° C. enables the Pt catalyst bed 374 to resist the deleterious affects of sulfur in the reformate, at least to some extent. Because of the relatively high temperature of the WGS reaction over the Pt bed 374, it is desirable to provide a heat exchanger (Hex) 88 to receive reformate via line 353 from the first stage 352 and deliver it to second stage 354 via line 353′ at a reduced temperature. The catalyst bed 372 of the second stage 354 is a Cu/ZnO catalyst for completing the WGS reaction. It will be appreciated that the WGS reaction dynamics are more moderate in this embodiment, relative to those of the FIGS. 2 and 3 embodiments, thus resulting in the requirement for the cumulative volume of the modified hybrid WGS reactor 350 to be somewhat greater than for the hybrid WGS reactors 150 and 250, as for example, 4-5 cu ft. It will be appreciated that although the FIG. 4 embodiment provides an initial WGS reaction bed of noble metal and a following reaction bed of Cu/ZnO, this embodiment differs from the FIG. 3 embodiment in that there is no further WGS reaction bed in the modified hybrid WGS reactor 350.

Although not separately depicted in FIGS. 2-4, it will be understood that the Cu/ZnO catalyst bed 172/272/372 of the respective hybrid WGS reactor section 150/250/350 may be regenerated by the passage of oxidant in contact therewith to form SO₂ and thereby remove adsorbed sulfur from the bed, in the general manner associated with the optional sulfur guard 70 of the FIG. 1 embodiment.

Although the invention has been described and illustrated with respect to the exemplary embodiments thereof, it should be understood by those skilled in the art that the foregoing and various other changes, omissions and additions may be made without departing from the spirit and scope of the invention. For instance, although the FPS has been described as including a desulfurizer upstream of a reformer, it will be understood that their relative positions may be reversed. Further, one or more heat exchangers may be used following the reformer and/or before each of the first and second stages of the WGS reactors if needed to control operating temperatures of the stages. Further still, to the extent oxygen leakage might also be a problem with a CSR type reformer, a configuration similar to the FIG. 3 embodiment may be used but is generally not required. Still further, while the first and second stages of the hybrid WGS reactor, as well as the O₂ guard bed, have been graphically depicted as having separate housings and separate catalyst beds for sake of discussion convenience, it will be understood that a gradation from one catalyst bed to the other may occur within a common housing, under appropriate thermal conditions, and still attain or retain the benefits of the invention. Indeed, the volume of the system may be minimized by employing such configuration. Of course, a requirement for a Hex between a pair of catalyst beds could complicate or prevent such arrangement.

1. A fuel processing system (FPS) (120, 220, 320) for receiving and converting a hydrocarbon feedstock fuel (22) to a hydrogen-rich reformate stream (34, 234, 56, 62), the FPS including, in combination, a reformer (30, 230) for reforming the hydrocarbon feedstock fuel (22) to a hydrogen-rich reformate having a 1^{st} level of CO and a multistage hybrid WGS reactor (150, 250, 350) for converting CO with H₂O in the reformate to H₂ and CO₂ to reduce the CO to a 2^{nd} level lower than the 1st, the multistage hybrid WGS reactor (150, 250, 350) having one stage (154, 254, 352) of active noble metal catalyst (174, 274, 374) and an other stage (152, 252, 354) of a Cu-based WGS catalyst (172, 272, 372), whereby the collective volume of said one and said other stages is small relative to a WGS reactor (50) having substantially only non-noble metal catalyst for reducing the CO level in a corresponding flow of the reformate from the 1^{st} level to the 2^{nd} level.

2. The fuel processing system (120, 220, 320) of claim 1 wherein the Cu-based WGS catalyst (172, 272, 372) of said other stage (152, 252, 354) provides sufficient sulfur guarding action to obviate requirement of a separate sulfur guard (70, 72).

3. The fuel processing system (120, 220) of claim 1 wherein the Cu-based WGS catalyst (172, 272) of said other stage (152, 252) precedes the active noble metal catalyst (174, 274) of said one stage (154, 254).

4. The fuel processing system (120, 220, 320) of claim 1 wherein the Cu-based WGS catalyst (172, 272, 372) comprises Cu/ZnO.

5. The fuel processing system (120, 220) of claim 3 wherein the Cu-based WGS catalyst (172, 272) comprises Cu/ZnO.

6. The fuel processing system (120, 220, 320) of claim 1 wherein the Cu-based WGS catalyst is supported on a thermally conductive metal support, and the Cu loading of the catalyst and support is relatively low, being not greater than about 2.0% of the combined catalyst and support weight, thereby to minimize shipping and handling requirements caused by self heat.

7. The fuel processing system (120, 220) of claim 5 wherein the active noble metal catalyst (174, 274) is selected from the group consisting of platinum, rhenium, and a combination thereof.

8. The fuel processing system (120) of claim 7 wherein the reformer (30) is of the CSR type.

9. The fuel processing system (220) of claim 7 wherein the reformer (230) is of the CPO/ATR type, and further including an oxygen guard (84, 82) between the reformer (230) and the Cu-based WGS catalyst of said other stage (252) of the hybrid WGS reactor (250).

10. The fuel processing system (220) of claim 9 wherein the oxygen guard (84, 82) comprises a catalyst (84) of noble metal.

11. The fuel processing system (220) of claim 10 wherein the noble metal catalyst (84) of the oxygen guard (82) comprises platinum.

12. The fuel processing system (120, 220, 320) of claim 1 wherein the collective volume of said one (154, 254, 352) and said other (152, 252, 354) stages of said multistage hybrid WGS reactor (150, 250, 350) is less than about one-half the volume of a conventional WGS reactor (50) having corresponding CO-converting capacity.

13. The fuel processing system (120, 220, 320) of claim 3 wherein the collective volume of said one (154, 254, 352) and said other (152, 252, 354) stages of said multistage hybrid WGS reactor (150, 250, 350) is less than about one-half the volume of a conventional WGS reactor (50) having corresponding CO-converting capacity.

14. The fuel processing system (120, 220, 320) of claim 1 wherein the reformer (230) is of the CPO/ATR type, and the active noble metal catalyst (374) of said one stage (352) precedes the Cu-based WGS catalyst (372) of said other stage (354).

15. The fuel processing system of claim 1 wherein the hydrogen-rich reformate stream (56, 62) issuing from the multistage hybrid WGS reactor (150, 250, 350) is operatively connected to a fuel cell (16) in a fuel cell power plant (10).
